(19) United States
(12) Patent Application Publication
(10) Pub. No.: US 2009/0135235 A1
(43) Pub. Date: May 28, 2009

(54) Pagewidth Inkjet Printer with Multiple Print head arrangement

(75) Inventor: Tareq Abduljalil Albahri, Jaber Al-Ali (KW)

Correspondence Address: FURR LAW FIRM, 2622 DEBOLT ROAD, UTICA, OH, 43080, US

(73) Assignee: University of Kuwait, Safat (KW)

(21) Appl. No.: 11/944,737

(22) Filed: Nov. 26, 2007

(51) Int. Cl. B41J 2/175

(52) U.S. Cl. 347/86

(57) ABSTRACT

There is disclosed an inkjet printer containing an array of stationary printheads/color-cartridges aligned along the page width of the page to be printed with overlapping and non-overlap arrangement. The printhead is in the form of an elongate printhead cartridge for use in a pagewidth printer and can be attached to the ink supply units along the sides and along a back surface thereof. The pagewidth inkjet printer has many advantages over the conventional inkjet printers with moving printhead/color cartridge assembly and the prior art patent pagewidth inkjet printer cartridge formed using MEMS techniques. Alternate overlapping printhead arrangement is provided ensuring no gaps in printed images due to the low nozzle packing densities permitted by the standard inkjet technologies for adequate print coverage of the printed page.

### FIELD OF THE INVENTION

The present invention relates to the construction of an inkjet printer pagewidth printhead cartridge and, in particular, to the packaging of the printhead with the ink supply manifold to the cartridge.

### BACKGROUND OF THE INVENTION

### Prior Art Reference and Discussion

It is known in the prior art that Inkjet printers contain moving (printhead and color-cartridge) assembly making the printer slow, require frequent calibration and can malfunction. Inkjet printers usually contain a moving printhead/color-cartridge assembly that moves from side to side (left and right) of the page to print portions of an image one strip at a time while the page intermittently moves forward to allow printing on the next strip thus forming the whole image which has many disadvantages.

It is thus desired to have a printer head that overcomes the above problems.

Many brands of inkjet printers are available in the market all of which use the old moving assembly design.

Among the prior art literatures that describe pagewidth printhead cartridge in inkjet printer are the U.S. patents enclosed the teachings of which are incorporated herein by reference.

Several US patent by Silverbrook et al. disclose using a single inkjet cartridge with Micro-Electro-Mechanical Systems (MEMS) manufacturing technique. (Complete PDF copies of the same are enclosed for reference).

U.S. Pat. No. 6,443,555 (2002) to Silverbrook, et al. for example discloses using large format (36 in) pagewidth inkjet printer including: a printhead assembly having an elongate pagewidth array of inkjet nozzles, chambers and thermal bend actuators. These printheads are formed using Micro-Electro-Mechanical Systems (MEMS) techniques that are similar to the manufacture of silicon computer chips. In this process, the ink nozzles and ejector mechanisms are formed in a series of etching and deposition procedures on silicon wafers as is the case with other computer chips, making cost an obstacle to the commercial manufacturer of pagewidth printheads.

Some newer large format plotters use this type of elongated pagewidth inkjet printhead cartridge from HP and other manufacturers. These are usually 10 to 20 times more expensive than the regular inkjet printers.

Accordingly, it is an object of the present invention to provide an inkjet printer, and in particular a desktop inkjet printer, which avoids the disadvantages of the prior art.

### DISADVANTAGES OF THE PRIOR ART

(1) Conventional inkjet printers contain moving (printhead and color-cartridge) assembly making the printer slow, require frequent calibration and can malfunction.
(2) Pagewidth inkjet cartridges with Micro-Electro-Mechanical Systems (MEMS) manufacturing technique is similar to the manufacture of silicon computer chips which are quite cumbersome and expensive.

It is thus desired to have an inkjet printer that overcomes the above problems.

### SUMMARY OF THE INVENTION

In view of forementioned problems we hereby propose to provide a solution that would provide for a stationary multiple printing head arrangement instead of the conventional single moving printing head or the single pagewidth cartridge arrangement disclosed in the prior art patent.

The inkjet printers multiple stationary printheads are preferably aligned in a single cartridge to cover the whole width of the page.

The current invention disclosed is an inkjet printer containing an array of stationary printheads/color-cartridges aligned along the page width of the page to be printed with overlapping and non-overlap arrangement. The printhead is in the form of an elongate printhead cartridge for use in a pagewidth printer and can be attached to the ink supply units along the sides and along a back surface thereof. The pagewidth inkjet printer has many advantages over the conventional inkjet printers with moving printhead/color cartridge assembly and the prior art patent pagewidth inkjet printer cartridge formed using MEMS techniques.

An alternate overlapping printhead arrangement is provided ensuring no gaps in printed images due to the low nozzle packing densities permitted by the standard inkjet technologies for adequate print coverage of the printed page.

### BRIEF DESCRIPTION OF THE DRAWINGS

The above and other aspects, features, and advantages of the present invention will be better and more fully understood by those skilled in the art with reference to the following detailed and more particular description of specific and preferred embodiments thereof, presented in conjunction with the following drawings to show how the same may be carried into effect, wherein:

FIG. 1 is a perspective view of a prior art inkjet printer with conventional moving print head arrangement with conventional horizontal one inch thick strips printing forming an integral image,

FIG. 2 illustrates a perspective view of the proposed inkjet printers stationary print head arrangement with vertical one inch thick strips printing forming an integral image constructed according to a preferred embodiment of the present invention; and

FIG. 3 illustrates a perspective view of an alternate overlapping printhead alignment in a pagewidth cartridge constructed according to another preferred embodiment of the present invention ensures no gaps in printed images due to the low nozzle packing densities permitted by the standard inkjet technologies.

### DETAILED DESCRIPTION OF BEST MODE FOR CARRYING OUT THE INVENTION

There will now be described, by way of example only, the best mode contemplated by the inventor for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

The above and other aspects, features and advantages of the present invention will be better and more fully understood by reference to the following detailed and more particular description of the invention, which is provided to further define the invention and are in no way meant to limit the scope of the invention to the particulars of these examples.

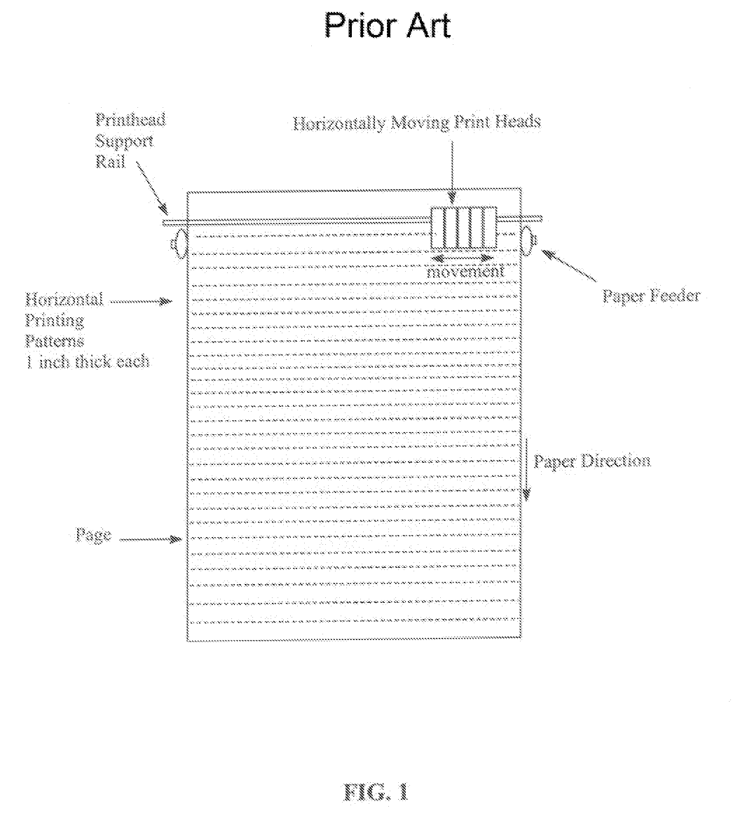

The prior art is shown in FIG. 1 which is a perspective view of an inkjet printer with conventional moving print head arrangement with conventional horizontal one inch thick strips printing forming an integral image.

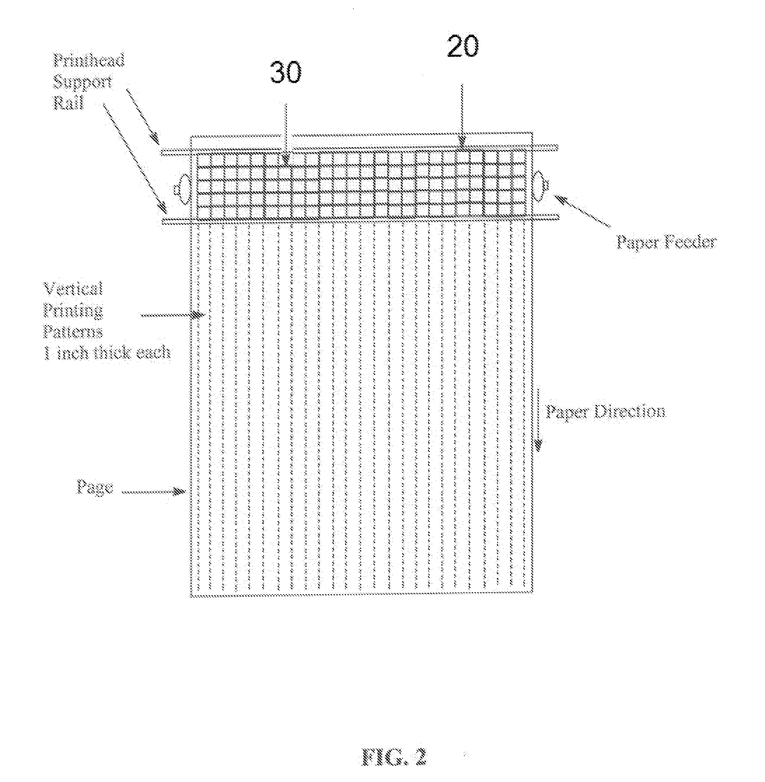

In one embodiment the present invention by referring to the accompanying drawings and in particular to FIG. 2, an inkjet printer constructed in accordance with the present invention comprises a stationary printhead arrangement preferable the printheads are enclosed in a single cartridge 20. Each printhead 30 is individually or pluraly connected to a feeding ink tank or reservoir. The printhead 30 is in the form of an elongate printhead cartridge 20 for use in a pagewidth printer and can be attached to the ink supply units along the sides and along a back surface thereof. FIG. 2 shows a black and four color (Cyan, Yellow, Blue, and Pink) printheads 20 arrangement aligned in each column. Alternatively it may be used a black and five color (Light Cyan, Light Magenta, Yellow, Cyan, and Magenta) printheads 20 arrangement aligned in each column. While the paper is moving through the printer internal, each column of printheads 20 can print vertical one inch think strip along the paper forming part of the whole image. The multitude of printhead columns further print additional one inch thick stripes along the paper, the plurality of which forms an integral image. The net result of such an inkjet printer with pagewidth printhead arrangement is that printing is done longitudinally one time without movement of the color cartridges (like in laser printing but with inkjet functionality). This printhead arrangement provides more uniform distribution of ink in the chamber and thus better spray on paper. It also provides for easy replacement of a single defective printhead when necessary instead of the whole pagewidth cartridge.

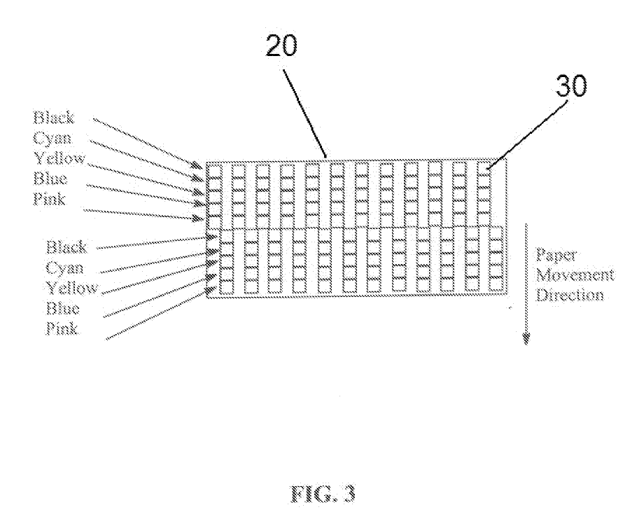

In a second embodiment of the present invention also by referring to the accompanying drawings and in particular to FIG. 3, an inkjet printer constructed in accordance with the present invention comprises a stationary print head arrangement preferably the printheads are enclosed in a single pagewidth cartridge wherein an alternate overlapping printhead alignment in the cartridge ensures no gaps in printed images due to the low nozzle packing densities permitted by the standard inkjet technologies and further allows for larger printheads.

### Disclaimers

Although the present invention has been described with reference to the preferred embodiment thereof, it is apparent to those skilled in the art that a variety of modifications and changes may be made without departing from the scope of the present invention which is intended to be defined by the appended claims.

Those skilled in the art will recognize that when automatic operation is required a regular automatic optional document feeder may be used to position each document sheet to the printer. This does not require significant modification by those skilled in the art.

The skilled in the art will also recognize that when an overlapping design is used as in FIG. 3 that a longer paper path is required and more space is required for the cartridge.

Those skilled in the art will easily recognize that the inkjet printer of the present invention maybe integrated with other devices or incorporated into multifunction imaging machines that scan, copy, fax, print, file, transmit, etc. using technology available to the skilled in the art without further experimentation. Furthermore, printed images may be directed manually or automatically from other devices such as fax machine, copier, or multifunction device, and the like.

### ADVANTAGES

(1) Provide easier (laser like) continuous paper printing mechanism versus the currently intermittent jerking movement that causes printer shaking, ensuring noiseless performance and faster printing.
(2) Stationary Pagewidth assembly with no moving parts ensures easier construction and operation.
(3) Pagewidth cartridge is easier to construct, assemble and maintain than prior art patents pagewidth cartridge. Printheads can be individually removed and replaced with new ones.

### EQUIVALENTS

From the foregoing description, one skilled in the art can easily ascertain the essential characteristics of this invention and, without departing from the spirit and scope thereof, can make various changes and modifications of the invention to adapt it to various usages and conditions. Such variations and changes may include, for example, altering the number of components in the housing or using equivalents. It is believed that such can be accomplished without excessive experimentation. In any case, any such variations are all claimed under the scope of this invention.

The methods of the present invention have been explained with reference to plurality of references the teachings of which are all incorporated herein by reference.

This invention has been described hereinabove, although with reference to a plurality of illustrative and preferred embodiments, it is to be understood that is in no way to be construed as limiting but only to provide examples. However, it is readily appreciated that, from reading this disclosure, the invention may be embodied in other specific forms without departing from the spirit or essential characteristics or attributes to bring modifications by replacing some elements of this invention as practiced by their equivalents, which would achieve that same goal thereof and accordingly reference should be made to the appended claims, rather than to the foregoing specification, as indicating the scope of the invention. Accordingly, those skilled in the art will recognize or be able to ascertain, using no more than routine experimentation, many equivalents to the specific embodiments and the scope of the invention being indicated by the appended claims described herein. Such equivalents, obvious variations, and all changes which come within the meaning and equivalency of the claims are therefore intended to be encompasses therein and are deemed covered by the claims of this invention.

From the foregoing description, one skilled in the art can easily ascertain the essential characteristics of this invention and, without departing from the spirit and scope thereof, can make various changes and modifications of the invention to adapt it to various usages and conditions. Such variations and changes may include, for example, altering the number of components in the housing or using equivalents. It is believed that such can be accomplished without excessive experimentation. In any case, any such variations are all claimed under the scope of this invention.

We claim:

1. An inkjet cartridge comprising:
a stationary cartridge with a plurality of printheads enclosed in said cartridge where each printheads are connected to a feeding ink tank.

2. An inkjet cartridge according to claim 1 further comprising:
where a single color is used.

3. An inkjet cartridge according to claim 1 further comprising:
where a plurality of colors are used.

4. An inkjet cartridge according to claim 1 further comprising:
where said printheads are aligned in a plurality of column on the print side of the cartridge.

5. An inkjet cartridge according to claim 4 further comprising:
where a plurality of colors are aligned in each column.

6. An inkjet cartridge according to claim 5 further comprising:
where said colors are black, cyan, yellow, blue and pink.

7. An inkjet cartridge according to claim 5 further comprising:
where said colors are black, light cyan, light magenta, yellow and cyan.

8. An inkjet cartridge according to claim 4 further comprising:
where each column can print a strip as a ink receiver moves by said cartridge.

9. An inkjet cartridge according to claim 4 further comprising:
where said ink receiver is paper.

10. An inkjet printer comprising:
having a stationary cartridge with a plurality of printheads enclosed in said cartridge where each printheads are connected to a feeding ink tank.

11. An inkjet printer according to claim 10 further comprising:
where a single color is used.

12. An inkjet printer according to claim 10 further comprising:
where a plurality of colors are used.

13. An inkjet printer according to claim 10 further comprising:
where said printheads are aligned in a plurality of column on the print side of the cartridge.

14. An inkjet printer according to claim 13 further comprising:
where a plurality of colors are aligned in each column.

15. An inkjet printer according to claim 14 further comprising:
where said colors are black, cyan, yellow, blue and pink.

16. An inkjet printer according to claim 14 further comprising:
where said colors are black, light cyan, light magenta, yellow and cyan.

17. An inkjet printer according to claim 13 further comprising:
where each column can print a strip as a ink receiver moves by said cartridge.

18. An inkjet printer according to claim 13 further comprising:
where said ink receiver is paper.

19. An inkjet printer comprising:
having a stationary cartridge with a plurality of printheads enclosed in said cartridge where each printheads are connected to a feeding ink tank where said printheads are aligned in a plurality of column on the print side of the cartridge where a plurality of colors are used where each column can print a strip as a ink receiver moves by said cartridge.

20. An inkjet printer according to claim 19 further comprising:
where said ink receiver is paper.
